(19) United States
(12) Patent Application Publication
(10) Pub. No.: US 2016/0278419 A1
(43) Pub. Date: Sep. 29, 2016

(54) STABILIZED LIQUID NUTRITIONALS INCLUDING INSOLUBLE CALCIUM SALTS

(71) Applicant: ABBOTT LABORATORIES, Abbott Park, IL (US)

(72) Inventors: Mustafa VURMA, Dublin, OH (US); Andre TERRELL, Columbus, OH (US); Carman GRILLS, Brockville (CA); Jeffrey BOFF, Dublin, OH (US); Gul KONUKLAR, New Albany, OH (US); Steven HARTLINE, Newark, OH (US)

(73) Assignee: ABBOTT LABORATORIES, Abbott Park, IL (US)

(21) Appl. No.: 14/442,640

(22) PCT Filed: Nov. 14, 2013
(86) PCT No.: PCT/US2013/070058

§ 371 Date: May 13, 2015

Related U.S. Application Data
(60) Provisional application No. 61/726,269, filed on Nov. 14, 2012.

(51) Int. Cl. A23L 1/30

(52) U.S. Cl. CPC A23L 1/304; A23L 1/3006; A23L 1/296; A23V 2002/00

(57) ABSTRACT

Disclosed are stabilized liquid nutritional compositions, including stabilized infant formulas, which comprise a first insoluble calcium salt, a second insoluble calcium salt and an emulsifier. The first insoluble calcium salt and the second insoluble calcium salt have different average particle sizes. The stabilized nutritional liquids are stable emulsions with good mineral suspension. Methods of manufacturing the stabilized liquid nutritional compositions are also disclosed.

### CROSS REFERENCE TO RELATED APPLICATIONS

This application claims priority to and any benefit of U.S. Provisional Application No. 61/726,269, filed Nov. 14, 2012, the entire contents of which are incorporated by reference in its entirety.

### FIELD OF THE DISCLOSURE

The present disclosure relates to a liquid nutritional composition having improved stability without the use of carrageenan or other stabilizers. More particularly, the liquid nutritional composition includes at least two insoluble calcium salts having different average particles sizes in combination with an emulsifier that desirably includes monoglycerides.

### BACKGROUND OF THE DISCLOSURE

Manufactured liquid nutritional composition comprising a targeted selection of nutrition ingredients are well known and widely available, some of which may provide a sole source of nutrition while others may provide a supplemental source. These nutritional liquids include powders that can be reconstituted with water or other aqueous liquid, as well as ready to drink nutritional liquids such as milk or protein based emulsions or non-emulsified or substantially clear liquids for use in infant and pediatric formulas and medical and adult nutritionals.

Traditionally, some liquid nutritional compositions have been confronted with at least two potential problems that can shorten shelf life. The first problem is known as creaming, whereby the fat globules in the liquid nutritional composition float to the top of the product. If these fat globules harden, a seal effectively forms across the top of the liquid nutritional composition's container. Additionally, these hard, fatty deposits can block or clog feeding tubes or nipples, and can give the liquid nutritional composition an unappealing appearance and cause nutritional insufficiencies.

The second problem potentially associated with liquid nutritional compositions is sedimentation, whereby minerals or other components, or both, precipitate out of solution and settle to the bottom of the liquid nutritional composition's container. The problem of sedimentation is made more acute where the sediment hardens into a cementous type of material known as “nondispersible sediment”. The problem with nondispersible sediment is two-fold. First, the liquid nutritional composition may potentially be subject to nutrient insufficiency as the nondispersible sediment often refuses to solubilize back into the solution upon agitation of the liquid nutritional composition. The second problem with nondispersible sediment is that, similar to hardened creaming deposits, it can plug feeding tubes or nipples.

Stabilizers are commonly used to maintain the rheological properties of the liquids over their shelf lives while maintaining their organoleptic properties and appearance. Although modified stabilizer systems have been proposed to address sedimentation problems, they have met with limited success. These systems permit the minerals to be suspended longer, but nevertheless, they can ultimately irreversibly fall out of solution.

Conventionally, one of the key components used in liquid nutritional compositions for product stability is carrageenan. Carrageenan is a group of highly sulfated, high molecular weight, linear polysaccharides. The functionality of carrageenan can be attributed to its chemical structure, especially the ester sulfate group content and molecular size. There are three main types of carrageenan: kappa, lambda and iota.

While carrageenan has proven relatively effective in stabilizing liquid nutritional compositions, there is a need in the art to find alternative methods for improving the physical stability of liquid nutritional products, and particularly infant nutritional products, specifically with regard to the avoidance of sedimentation of insoluble minerals and the creaming of fats. More particularly, liquid nutritional compositions that can be stabilized without the use of carrageenans or other stabilizers would be especially advantageous for those matrices where stabilization with carrageenans proves inadequate. Further, carrageenans do not enjoy universal acceptance, and can be subject to restrictive regulation.

The present disclosure is directed to nutritional products in the form of liquid nutritional compositions comprising at least two insoluble calcium salts and one or more emulsifiers, including monoglycerides. The combination of insoluble calcium salt and emulsifiers allows for a stable emulsion with good mineral suspension.

### SUMMARY OF THE DISCLOSURE

The present disclosure is directed to a stabilized liquid nutritional composition comprising a first insoluble calcium salt, a second insoluble calcium salt, an emulsifier, and a fat. The first insoluble calcium salt and the second insoluble calcium salt have different average particle sizes.

The present disclosure is further directed to a stabilized liquid infant formula comprising a first insoluble calcium salt, a second insoluble calcium salt, an emulsifier, and a fat. The first insoluble calcium salt and the second insoluble calcium salts have different average particle sizes and the first insoluble calcium salt and the second insoluble calcium salt are selected from the group consisting of calcium carbonate, calcium citrate, calcium phosphate, dicalcium phosphate, tricalcium phosphate and combinations thereof. In certain embodiments disclosed herein, the emulsifier comprises monoglycerides.

The present disclosure is further directed to a process for manufacturing a stabilized liquid nutritional composition. The process comprises introducing a first insoluble calcium salt, a second insoluble calcium salt, and an emulsifier with a fat to form a fat blend. The first insoluble calcium salt and the second insoluble calcium salt have different average particle sizes. The emulsifier comprises monoglycerides. The fat blend is mixed with a carbohydrate blend to form the stabilized liquid.

The stabilized liquid nutritional products as described herein not only provide sufficient nutritional benefits for individuals, but are also universally label friendly. More particularly, it has been unexpectedly found that when at least two insoluble calcium salts having different average particle sizes are combined with an emulsifier, stable liquid nutritional products can be prepared without the use of added stabilizers. The liquid nutritional products provide good mineral suspension such to minimize mineral fallout, allowing for homogenous and precise delivery of micro and minor nutrients to infants and pediatric individuals.

### DETAILED DESCRIPTION OF THE DISCLOSURE

The liquid nutritional products of the present disclosure comprise at least two insoluble calcium salts having different average particles sizes and an emulsifier. These and other essential features of the nutritional products, as well as some of the many optional variations and additions, are described in detail hereafter.

The term “insoluble calcium salt” as used herein, unless otherwise specified, refers to calcium salts that are substantially insoluble in water at room temperature, and specifically to calcium salts that are less than 1 wt. % or less than 0.5 wt. % or less than 0.1 wt. % soluble in water at room temperature.

The terms “liquid nutritional product” “liquid nutritional composition” and “nutritional liquid” are used interchangeably herein, and unless otherwise specified, refer to nutritional products in ready-to-drink liquid form and concentrated form comprising one or more of fat, protein, and carbohydrate.

The terms “fat” and “oil” as used herein, unless otherwise specified, are used interchangeably to refer to lipid materials derived or processed from plants or animals. These terms also include synthetic lipid materials so long as such synthetic materials are suitable for oral administration to humans.

The term “shelf stable” as used herein, unless otherwise specified, refers to a liquid nutritional composition that remains commercially stable after being packaged and then stored at 18-24° C. for at least 3 months, including from about 6 months to about 24 months, and also including from about 12 months to about 18 months.

The terms “retort packaging” and “retort sterilizing” are used interchangeably herein, and unless otherwise specified, refer to the common practice of filling a container, most typically a metal can or other similar package, with a liquid nutritional composition and then subjecting the liquid-filled package to the necessary heat sterilization step, to form a sterilized, retort packaged, liquid nutritional product.

The term “aseptic packaging” as used herein, unless otherwise specified, refers to the manufacture of a packaged product without reliance upon the above-described retort packaging step, wherein the liquid nutritional composition and package are sterilized separately prior to filling, and then are combined under sterilized or aseptic processing conditions to form a sterilized, aseptically packaged, liquid nutritional product.

The term “infant formula” as used herein, unless otherwise specified, refers to liquid infant formulas and pediatric formulas, wherein infant formulas are intended for infants up to about 1 year of age and toddler formulas are intended for children from about 1 year of age to about 10 years of age.

The term “preterm infant formula” as used herein, unless otherwise specified, refers to liquid nutritional compositions suitable for consumption by a preterm infant. The term “preterm infant” as used herein, refers to a person born prior to 36 weeks of gestation.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the nutritional products of the present disclosure may also be substantially free of any optional or selected essential ingredient or feature described herein, provided that the remaining nutritional product still contains all of the required ingredients or features as described herein. In this context, and unless otherwise specified, the term “substantially free” means that the selected nutritional product contains less than a functional amount of the optional ingredient, typically less than about 1%, including less than about 0.5%, including less than about 0.1%, and also including zero percent, by weight of such optional or selected essential ingredient.

The nutritional product may comprise, consist of, or consist essentially of the essential elements of the products as described herein, as well as any additional or optional element described herein or otherwise useful in nutritional product applications.

### Product Form

The liquid nutritional compositions of the present disclosure include both concentrated and ready-to-feed liquid nutritional compositions. These liquid nutritional compositions are most typically formulated as suspensions or emulsions. Suitable product forms in the present disclosure include preterm and term infant formulas, pediatric/toddler formulas, and follow on formulas.

The nutritional products may be formulated with sufficient kinds and amounts of nutrients to provide a sole, primary, or supplemental source of nutrition, or to provide a specialized nutritional product for use in individuals afflicted with specific diseases or conditions or with a targeted nutritional benefit.

The nutritional liquids typically contain up to about 95% by weight of water, including from about 50% to about 95%, also including from about 60% to about 90%, and also including from about 70% to about 85%, of water by weight of the nutritional liquid. The nutritional liquids may have a variety of product densities, but most typically have a density greater than about 1.03 g/mL, including greater than about 1.04 g/mL, including greater than about 1.055 g/mL, including from about 1.06 g/mL to about 1.12 g/mL, and also including from about 1.085 g/mL to about 1.1 g/mL.

The nutritional liquids may have a caloric density tailored to the nutritional needs of the ultimate user. In certain embodiments, the liquids comprise at least about 640 kcal/liter (about 19 kcal/fl oz), more particularly from about 675 kcal/liter (about 20 kcal/fl oz) to about 845 kcal/liter (about 25 kcal/fl oz), more particularly from about 675 kcal/liter (about 20 kcal/fl oz) to about 815 kcal/liter (about 24 kcal/fl oz). Generally, the about 740 kcal/liter (about 22 kcal/fl oz) to about 815 kcal/liter (about 24 kcal/fl oz) formulas are more commonly used in preterm or low birth weight infants, and the about 675 kcal/liter (about 20 kcal/fl oz) to about 710 kcal/liter (about 21 kcal/fl oz) formulas are more often used in term infants. In certain other embodiments, the liquid may have a caloric density of from about 100 kcal/liter to about 660 kcal/liter, particularly from about 150 kcal/liter to about 500 kcal/liter.

The nutritional liquids may have a pH ranging from about 3.5 to about 8, but are most advantageously in a range of from about 4.5 to about 7.5, including from about 5.5 to about 7.3, including from about 6.2 to about 7.2.

Although the serving size for the nutritional liquid can vary depending upon a number of variables, a typical serving size is generally at least about 2 mL, in particular embodiments at least about 5 mL, in other particular embodiments at least about 10 mL, in other particular embodiments at least about 25 mL, including ranges from about 2 mL to about 300 mL, including from about 4 mL to about 250 mL, and including from about 10 mL to about 240 mL.

### Insoluble Calcium Salt

The liquid nutritional products comprise at least two, including at least three, or more insoluble calcium salts in combination with an emulsifier, such as monoglycerides, as discussed below. The insoluble calcium salts may be any insoluble calcium salt known for use in oral nutritional products, and may include, for example, calcium carbonate, calcium citrate, calcium monophosphate, calcium diphosphate, tricalcium phosphate, and combinations thereof.

The two or more insoluble calcium salts that are included in the liquid nutritional have different average particle sizes. It has been unexpectedly found that utilizing at least two insoluble calcium salts having different average particle sizes actually minimizes precipitation and sedimentation in the liquid nutritional, thereby, providing sufficient calcium to the consumer and increasing long term product stability.

Particle size measurements were performed using a laser diffraction particle size analyzer (HELOS model KR with a RODOS M dry dispersing unit; Sympatec GmbH, Clausthal-Zellerfeld, Germany). Two lenses (R2 and R6) were utilized on measurements of calcium salts based on their average particle size values. As used herein, “average particle size” refers to the volume mean diameter of each particle, determined based on the particle size distribution as measured by the laser diffraction particle size analyzer. The average particle size of the insoluble calcium salts falls within the range of from about 0.35 μm to about 15.25 μm, including from about 0.5 μm to about 10 μm, including from about 0.65 μm to about 8 μm, including from about 1.25 μm to about 5 μm, and including from about 2 μm to about 3.5 μm. It is desirable to include at least two, or even three or more, insoluble calcium salts in the liquid nutritional products, each salt having a different average particle size. In certain embodiments, three insoluble calcium salts are included in the liquid nutritional, the first insoluble calcium salt has an average particle size of from about 1.5 μm to about 2.5 μm, the second insoluble calcium salt has an average particle size of from about 2 μm to about 3 μm, and the third insoluble calcium salt has an average particle size of from about 2.5 μm to about 4.5 μm. In one particular embodiment, three insoluble calcium salts are included in the liquid nutritional, the first insoluble calcium salt, tricalcium phosphate, has an average particle size of about 2.3 μm, the second insoluble calcium salt, calcium carbonate, has an average particle size of about 2.74 μm, and the third insoluble calcium salt, calcium citrate, has an average particle size of about 3.92 μm.

The total amount of the two or more insoluble calcium salts in the liquid nutritional products will depend on the other components of the liquid nutritional product and the targeted use of the nutritional product, but will generally fall within the range of from about 0.02 wt. % to about 1 wt. % of the liquid nutritional product. The insoluble calcium salts are present in the liquid nutritional products in a weight ratio of from about 20:80 to about 80:20, including from about 30:70 to about 70:30, including from about 40:60 to about 60:40, and including from about 50:50. For example, in one embodiment, two insoluble calcium salts, tricalcium phosphate and calcium citrate, are present in the liquid nutrition in a weight ratio of about 50:50. In another embodiment, three insoluble calcium salts are present in the liquid nutritional in a weight ratio of tricalcium phosphate:calcium citrate:calcium carbonate of about 40:30:30. In yet another embodiment, the insoluble calcium salts are present in a weight ratio of tricalcium phosphate:calcium citrate:calcium carbonate of about 60:20:20. Accordingly, in some embodiments, the insoluble calcium salts may individually be present in the liquid nutritional products in amounts ranging from about 0.004 wt. % to about 0.016 wt. %, including from about 0.006 wt. % to about 0.014 wt. %, including from about 0.008 wt. % to about 0.012 wt. %, and including about 0.01 wt. %. In yet other embodiments, the insoluble calcium salts are individually present in the liquid nutritional products in amounts ranging from about 0.2 wt. % to about 0.8 wt. %, including from about 0.3 wt. % to about 0.7 wt. %, including from about 0.4 wt. % to about 0.6 wt. % and including about 0.5 wt. %.

### Emulsifier

The liquid nutritional formulations of the present disclosure further comprise at least one emulsifier in combination with the insoluble calcium salts. The emulsifier is desirably monoglycerides (including distilled monoglycerides) and may include, but is not limited to, monoglycerides, diglycerides, triglycerides, free glycerol, free fatty acids, and combinations thereof. Other suitable emulsifiers for use in the liquid nutritional formulations include lecithins. Other suitable emulsifiers for use include both monoglycerides and/or diglycerides in combination with lecithin. The emulsifier may act to suspend/trap the calcium salts and allow the calcium salts to remain in solution for longer periods of time. Further, the emulsifier is capable of re-suspending the insoluble calcium salts should any precipitation occur.

The emulsifiers are present in the liquid nutritional formulations in amounts of no more than 12% by weight of total fat component included in the liquid nutritional product, including no more than 6% by weight of total fat component included in the liquid nutritional product, including from about 0.5% to about 10% by weight of total fat component included in the liquid nutritional product, including from about 2% to about 8% by weight of total fat component included in the liquid nutritional product, and also including from 4.5% to about 7% by weight of total fat component included in the liquid nutritional product. In one exemplary embodiment, monoglycerides and lecithin are included as emulsifiers in the liquid nutritional product, wherein about 6% by weight of total fat component is monoglycerides and about 1.5% by weight of total fat component is lecithin.

In accordance with the present disclosure, the liquid nutritional products that include the at least two insoluble calcium salts having different average particle sizes in combination with the emulsifier, desirably the distilled monoglycerides, can be formulated such that additional stabilizers are not required to produce a commercially suitable product. Specifically, the liquid nutritional products can be formulated to be substantially carrageenan-free, including completely carrageenan-free.

### Protein

The liquid nutritional products may further comprise any protein or sources thereof that are suitable for use in oral liquid nutritional products and are compatible with the essential elements and features of such products. Total protein concentrations in the liquid nutritional products may range from about 0.5% to about 30%, including from about 1% to about 15%, and also including from about 2% to about 10%, by weight of the liquid nutritional product.

Non-limiting examples of suitable protein or sources thereof for use in the nutritional products include hydrolyzed, partially hydrolyzed or non-hydrolyzed proteins or protein sources, which may be derived from any known or otherwise suitable source such as milk (e.g., casein, whey), animal (e.g., meat, fish), cereal (e.g., rice, corn), vegetable (e.g., soy) or combinations thereof. Non-limiting examples of such proteins include milk protein isolates, milk protein concentrates as described herein, casein protein isolates, whey protein, sodium or calcium caseinates, whole cow's milk, partially or completely defatted milk, soy protein isolates, soy protein concentrates, and so forth.

### Carbohydrate

The liquid nutritional products may further comprise any carbohydrates or sources thereof that are suitable for use in an oral liquid nutritional product and are compatible with the essential elements and features of such products. Carbohydrate concentrations in the liquid nutritional products, for example, may range from about 5% to about 40%, including from about 7% to about 30%, and including from about 10% to about 25%, by weight of the liquid nutritional composition.

Non-limiting examples of suitable carbohydrates or sources thereof for use in the nutritional products described herein may include maltodextrin, glucose polymers, corn syrup, corn syrup solids, rice-derived carbohydrates, sucrose, glucose, fructose, lactose, high fructose corn syrup, honey, sugar alcohols (e.g., maltitol, erythritol, sorbitol), artificial sweeteners (e.g., sucralose, acesulfame potassium, stevia) and combinations thereof.

### Fat

In addition to the emulsifier described above, the liquid nutritional products comprise additional fat or sources thereof, most typically as emulsified fat, concentrations of which may range from about 1% to about 30%, including from about 2% to about 15%, and also including from about 4% to about 10%, by weight of the liquid nutritional composition.

Suitable sources of additional fat for use herein include any fat or fat source that is suitable for use in an oral liquid nutritional product and is compatible with the essential elements and features of such products.

Non-limiting examples of suitable fats or sources thereof for use in the liquid nutritional products described herein include coconut oil, fractionated coconut oil, soy oil, corn oil, olive oil, safflower oil, high oleic safflower oil, MCT oil (medium chain triglycerides), sunflower oil, high oleic sunflower oil, palm and palm kernel oils, palm olein, canola oil, marine oils, cottonseed oils, and combinations thereof.

The amount of protein, fats, and proteins, if present, in any of the liquid nutritional products described herein may also be characterized in addition to, or in the alternative, as a percentage of total calories in the nutritional product as set forth in the following table. These macronutrients for liquid nutritional products of the present disclosure are most typically formulated within any of the caloric ranges (embodiments A-F) described in the following table (each numerical value is preceded by the term “about”).

| Nutrient & Total Cal. | Embodiment A | Embodiment B | Embodiment C |
|---|---|---|---|
| Carbohydrate | 0-98 | 2-96 | 10-75 |
| Protein | 0-98 | 2-96 | 5-70 |
| Fat | 0-98 | 2-96 | 20-85 |
| | Embodiment D | Embodiment E | Embodiment F |
| Carbohydrate | 30-50 | 25-50 | 25-50 |
| Protein | 15-35 | 10-30 | 5-30 |
| Fat | 35-55 | 1-20 | 2-20 |

In one specific example, liquid infant formulas (both ready-to-feed and concentrated liquids) include those embodiments in which the protein component may comprise from about 7.5% to about 25% of the caloric content of the formula; the carbohydrate component may comprise from about 35% to about 50% of the total caloric content of the infant formula; and the fat component (inclusive of the emulsifier) may comprise from about 30% to about 60% of the total caloric content of the infant formula. These ranges are provided as examples only, and are not intended to be limiting. Additional suitable ranges are noted in the following table (each numerical value is preceded by the term “about”).

| Nutrient & Total Cal. | Embodiment G | Embodiment H | Embodiment I |
|---|---|---|---|
| Carbohydrate | 20-85 | 30-60 | 35-55 |
| Protein | 5-70 | 20-60 | 25-50 |
| Fat | 2-75 | 5-50 | 7-40 |

### Optional Ingredients

The liquid nutritional products described herein may further comprise other optional ingredients that may modify the physical, chemical, hedonic or processing characteristics of the products or serve as pharmaceutical or additional nutritional components when used in the targeted population. Many such optional ingredients are known or otherwise suitable for use in other nutritional products and may also be used in the nutritional products described herein, provided that such optional ingredients are safe and effective for oral administration and are compatible with the essential and other ingredients in the selected product form.

Non-limiting examples of such optional ingredients include preservatives, antioxidants, emulsifying agents, buffers, pharmaceutical actives, additional nutrients as described herein, colorants, flavors, thickeners, and so forth. While not required, additional stabilizers may also be included without deviating from the present disclosure.

The products may further comprise vitamins or related nutrients, non-limiting examples of which include vitamin A, vitamin D, vitamin E, vitamin K, thiamine, riboflavin, pyridoxine, vitamin B12, carotenoids, niacin, folic acid, pantothenic acid, biotin, vitamin C, choline, inositol, salts, and derivatives thereof, and combinations thereof.

The products may further comprise minerals (in addition to the insoluble calcium salts), non-limiting examples of which include phosphorus, magnesium, iron, zinc, manganese, copper, sodium, potassium, molybdenum, chromium, selenium, chloride, and combinations thereof.

The products may also include one or more flavoring or masking agents. Suitable flavoring or masking agents include natural and artificial sweeteners, sodium sources such as sodium chloride, and hydrocolloids, and combinations thereof.

### Methods of Manufacture

The liquid nutritional products for use herein may be manufactured by any known or otherwise suitable method for making the nutritional product form selected. Nutritional liquids may be prepared, for example, by any of the well known methods of formulating nutritional liquids by way of retort, aseptic packaging, or hot fill processing methods. Such methods are well known in the nutrition formulation and manufacturing arts.

In one suitable manufacturing process, for example, at least three separate slurries are prepared, including a protein-in-fat (PIF) slurry, a carbohydrate-mineral (CHO-MIN) slurry, a protein-in-water (PIW) slurry. The PIF slurry is formed by heating and mixing an oil blend (e.g., canola oil, corn oil, etc.) and then adding an emulsifier, fat soluble vitamins, and a portion of the total protein (e.g., milk protein concentrate, etc.) with continued heat and agitation. The CHO-MIN slurry is formed by adding with heated agitation to water: minerals (e.g., potassium citrate, dipotassium phosphate, sodium citrate, etc.) and trace and ultra trace minerals (TM/UTM premix). The resulting CHO-MIN slurry is held for 10 minutes with continued heat and agitation before adding additional minerals (e.g., potassium chloride, magnesium carbonate, potassium iodide, etc.) or carbohydrates (e.g., HMOs, fructooligosaccharide, sucrose, corn syrup, etc.), or both. The PIW slurry is then formed by mixing with heat and agitation the remaining protein, if any.

The resulting slurries are then blended together with heated agitation and the pH adjusted to 6.5-7.6, after which the composition is subjected to high-temperature short-time (HTST) processing during which the composition is heat treated, emulsified and homogenized, and then allowed to cool. Water soluble vitamins and ascorbic acid are added, the pH is adjusted to the desired range if necessary, favors are added, and water is added to achieve the desired total solid level. The composition is then aseptically packaged to form an aseptically packaged nutritional emulsion. This emulsion can then be further diluted, heat-treated, and packaged to form a ready-to-feed or concentrated liquid.

To form the stabilized liquid nutritional composition of the present disclosure, the insoluble calcium salts in combination with the emulsifier are desirably introduced into the PIF (also commonly referred to in the art as an “oil blend”) slurry prior to blending the slurries (PIF and CHO/MIN) to form the liquid nutritional composition. It has been found that by adding the insoluble calcium salts and emulsifier with the oil blend of the PIF slurry, calcium remains in suspension for a longer period of time. Further, any calcium salts that may fall out of suspension are more easily re-suspended when the calcium salt is added to the oil blend during manufacturing.

### Methods of Use

The liquid nutritional compositions as described herein comprise insoluble calcium salt and emulsifiers that not only provide sufficient nutritional benefits for individuals, but also allow for an improved stabilized liquid nutritional product having universal acceptance. More particularly, the stabilized liquid nutritional product may provide for homogenous and precise delivery of calcium, as well as other micro and minor nutrients, to infants and toddlers.

Further, the stabilized liquid nutritional products remain in a single homogenous phase; that is, without physical separation for longer periods of time, allowing for a more aesthetic pleasing product. Surprisingly, the stabilized liquid nutritional products, having no sedimentation or phase separation, can be maintained for at least 12 hours, including at least 18 hours, including at least 24 hours, and also including at least 48 hours.

The physically stable nutritional product of the present disclosure is prepared without the use of carrageenan or other added stabilizer. More particularly, the liquid nutritional products of the present disclosure are substantially free of carrageenan; that is, the nutritional products include carrageenan in an amount of less than 1% by weight, including less than 0.5%, including less than 0.1%, including less than 0.01%, and also including zero percent by weight of the nutritional product.

### EXAMPLES

The following examples illustrate specific embodiments and or features of the nutritional products of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the composition, unless otherwise specified.

The exemplified compositions are nutritional products prepared in accordance with manufacturing methods well known in the nutrition industry for preparing nutritional emulsions, and nutritional non-emulsions (e.g., substantially clear nutritional liquids).

### Example 1

In this Example, the stability after six months of infant formulas prepared with tricalcium phosphate, calcium citrate, and calcium carbonate as stabilizers was analyzed and compared to the stability after six months of infant formulas prepared with carrageenan.

Liquid infant formulas were prepared using the methods described herein. Two control formulas were prepared including carrageenan as the stabilizer. Two additional test formulas were prepared replacing the carrageenan with three insoluble calcium salts, tricalcium phosphate, calcium citrate and calcium carbonate, present in a weight ratio of tricalcium phosphate:calcium citrate:calcium carbonate of about 40:30:30.

Immediately after preparation, the amounts of calcium and phosphate in solution were determined in the formulas. After 6 months, the formulas were shaken, three cycles/second for four seconds, and the amounts of calcium and phosphate in solution were again determined in the formulas. The results are shown in the table below.

TABLE
Calcium (mg/100 g) and Phosphorous (mg/100 g) Recovery at 6 months

| | | |
|---|---|---|
| Initial | | |
| Preparation | After 6 months | After 12 months |

Calcium Recovery

| | | | |
|---|---|---|---|
| Control formula 1 | 57.8 | 57.0 | 56.1 |
| Control formula 2 | 54.2 | 54.3 | 53.8 |
| Test formula 1 | 53.6 | 53.0 | 51.3 |
| Test formula 2 | 52.1 | 57.8 | 55.1 |

Phosphorous Recovery

| | | | |
|---|---|---|---|
| Control formula 1 | 35.6 | 33.8 | 34.4 |
| Control formula 2 | 33.9 | 33.6 | 33.4 |
| Test formula 1 | 32.3 | 31.8 | 31.3 |
| Test formula 2 | 31.6 | 33.8 | 32.8 |

As shown in the table, the amount of calcium in solution was the same or even higher as compared to the amount at initial preparation upon shaking the formulas after 6 months using the insoluble salts or carrageenan as stabilizers. Similarly, the amount of phosphate in solution was the same or even higher as compared to the amount at initial preparation upon shaking the formulas after 6 months using the insoluble salts or carrageenan as stabilizers. Further, it was shown that the insoluble salts behaved as well or better than the carrageenan as stabilizers in the infant formulas.

### Examples 2-6

Examples 2-6 illustrate nutritional emulsions of the present disclosure including insoluble calcium salts and monoglycerides, the ingredients of which are listed in the table below. All ingredient amounts are listed as kilogram per approximately 1000 kg batch of product, unless otherwise specified.

The nutritional emulsions were prepared by making at least two separate slurries that were later blended together, heat treated, standardized, and terminally sterilized. Initially, a carbohydrate-mineral slurry was prepared by dissolving the selected carbohydrates (e.g. lactose, galactooligosaccharides) in water at 74-79° C., followed by the addition of citric acid, magnesium chloride, potassium chloride, potassium citrate, choline chloride, and sodium chloride. The resulting slurry was held under moderate agitation at 49-60° C. until it was later blended with the other prepared slurries.

A protein-in-fat slurry was prepared by combining the high oleic safflower oil, coconut oil, monoglycerides and soy lecithin under agitation and heating to 66-79° C. Following a 10-15 minute hold time, soybean oil, mixed carotenoid premix, vitamin A, calcium carbonate, tricalcium phosphate, ARA oil, DHA oil, and whey protein concentrate were then added to the slurry. The resulting oil slurry was held under moderate agitation at 49-60° C. until it was later blended with the other prepared slurries.

Water was heated to 49-60° C. and then combined with the carbohydrate-mineral slurry, nonfat milk, and the protein-in-fat slurry under adequate agitation. The pH of the resulting blend was adjusted with potassium hydroxide. This blend was held under moderate agitation at 49-60° C.

The resulting blend was heated to 74-79° C., emulsified through a single stage homogenizer to 900-1100 psig, and then heated to 144-147° C., for about 5 seconds. The heated blend was passed through a flash cooler to reduce the temperature to 88-93° C. and then through a plate cooler to further reduce the temperature to 74-85° C. The cooled blend was then homogenized at 2900-3100/400-600 psig, held at 74-85° C. for 16 seconds, and then cooled to 2-7° C. Samples were taken for analytical testing. The mixture was held under agitation at 2-7° C.

A water-soluble vitamin (WSV) solution and an ascorbic acid solution were prepared separately and added to the processed blended slurry. The vitamin solution was prepared by adding the following ingredients to water with agitation: potassium citrate, ferrous sulfate, WSV premix, L-carnitine, potassium phosphate, riboflavin, inositol, and the nucleotide-choline premix. The ascorbic acid solution was prepared by adding potassium hydroxide and ascorbic acid to a sufficient amount of water to dissolve the ingredients. The ascorbic acid solution pH was then adjusted to 5-9 with potassium hydroxide.

The blend pH was adjusted to a specified pH range of 6.5-7.6 with potassium hydroxide (varied by product) to achieve optimal product stability. The completed product was then filled into suitable containers and thermally sterilized.

| Ingredient Name | Example 2 | | Example 3 | | Example 4 | | Example 5 | | Example 6 | |
|---|---|---|---|---|---|---|---|---|---|---|
| Ingredient water | Q.S. | | Q.S. | | Q.S. | | Q.S. | | Q.S. | |
| Lactose | 48.7 | | 48.7 | | 48.7 | | 48.7 | | 48.7 | |
| Nonfat dry milk | 22 | | 22 | | 22 | | 22 | | 22 | |
| High oleic safflower oil | 12.9 | | 12.9 | | 12.9 | | 12.9 | | 12.9 | |
| Soy oil | 9.7 | | 9.7 | | 9.7 | | 9.7 | | 9.7 | |
| Galactooligosaccharides | 9.2 | | 9.2 | | 9.2 | | 9.2 | | 9.2 | |
| (GOS) | | | | | | | | | | |
| Coconut oil | 9.2 | | 9.2 | | 9.2 | | 9.2 | | 9.2 | |
| Whey protein concentrate | 6.3 | | 6.3 | | 6.3 | | 6.3 | | 6.3 | |
| Monoglycerides | 1.9 | | 1.9 | | 1.9 | | 1.9 | | 1.9 | |
| Potassium citrate | 690 | g | 690 | g | 690 | g | 690 | g | 690 | g |
| Ascorbic Acid | 612 | g | 612 | g | 612 | g | 612 | g | 612 | g |
| Potassium hydroxide 45% | 410 | g | 410 | g | 410 | g | 410 | g | 410 | g |
| (processing aid) | | | | | | | | | | |
| Arachidonic acid (AA) | 395 | g | 395 | g | 395 | g | 395 | g | 395 | g |
| Lecithin | 347 | g | 347 | g | 347 | g | 347 | g | 347 | g |
| Calcium Citrate (avg. particle | 319 | g | 303 | g | 287 | g | 335 | g | 350 | g |
| size 3.92 μm) | | | | | | | | | | |
| Nucleotide/choline premix | 315 | g | 315 | g | 315 | g | 315 | g | 315 | g |
| Docosahexaenoic acid (DHA) | 207 | g | 207 | g | 207 | g | 207 | g | 207 | g |
| Water soluble | 176 | g | 176 | g | 176 | g | 176 | g | 176 | g |
| vitamin/UTM/amino acid | | | | | | | | | | |
| premix | | | | | | | | | | |
| Sodium citrate | 175 | g | 175 | g | 175 | g | 175 | g | 175 | g |
| Calcium Carbonate avg. | 168 | g | 160 | g | 150 | g | 176 | g | 185 | g |
| particle size (2.74 μm) | | | | | | | | | | |
| Sodium chloride | 156 | g | 156 | g | 156 | g | 156 | g | 156 | g |
| Tricalcium Phosphate (avg. | 139 | g | 145 | g | 153 | g | 132 | g | 125 | g |
| particle size 2.30 μm) | | | | | | | | | | |
| Magnesium chloride | 118 | g | 118 | g | 118 | g | 118 | g | 118 | g |
| Mixed carotenoid premix | 72.9 | g | 72.9 | g | 72.9 | g | 72.9 | g | 72.9 | g |
| Vitamin A, D₃, E and K₁ | 48.2 | g | 48.2 | g | 48.2 | g | 48.2 | g | 48.2 | g |
| premix pediatric products | | | | | | | | | | |
| Choline Chloride | 45 | g | 45 | g | 45 | g | 45 | g | 45 | g |
| Ferrous sulfate | 29 | g | 29 | g | 29 | g | 29 | g | 29 | g |
| Zinc sulfate | 17.9 | g | 17.9 | g | 17.9 | g | 17.9 | g | 17.9 | g |
| L-Carnitine | 5.5 | g | 5.5 | g | 5.5 | g | 5.5 | g | 5.5 | g |
| Cupric sulfate | 1.9 | g | 1.9 | g | 1.9 | g | 1.9 | g | 1.9 | g |
| Manganese sulfate | 109 | mg | 109 | mg | 109 | mg | 109 | mg | 109 | mg |

### Examples 7-11

Examples 7-11 illustrate nutritional emulsions of the present disclosure including insoluble calcium salts and monoglycerides, the ingredients of which are listed in the table below. All ingredient amounts are listed as kilogram per approximately 1000 kg batch of product, unless otherwise specified.

The nutritional emulsions were prepared by making at least two separate slurries that were later blended together, heat treated, standardized, and terminally sterilized as described in Examples 2-6.

| Ingredient Name | Example 7 | | Example 8 | | Example 9 | | Example 10 | | Example 11 | |
|---|---|---|---|---|---|---|---|---|---|---|
| Ingredient Water | Q.S | | Q.S | | Q.S | | Q.S | | Q.S | |
| Nonfat Dry Milk | 37.9 | | 37.9 | | 37.9 | | 37.9 | | 37.9 | |
| Corn Syrup Solids | 37.9 | | 37.9 | | 37.9 | | 37.9 | | 37.9 | |
| Lactose | 18 | | 18 | | 18 | | 18 | | 18 | |
| Whey Protein Concentrate | 17.2 | | 17.2 | | 17.2 | | 17.2 | | 17.2 | |
| Medium Chain Triglycerides | 16.4 | | 16.4 | | 16.4 | | 16.4 | | 16.4 | |
| Soy Oil - IP | 11.9 | | 11.9 | | 11.9 | | 11.9 | | 11.9 | |
| Coconut Oil | 7.25 | | 7.25 | | 7.25 | | 7.25 | | 7.25 | |
| 5% KOH | 4.23 | | 4.23 | | 4.23 | | 4.23 | | 4.23 | |
| High Oleic Safflower Oil | 3.47 | | 3.47 | | 3.47 | | 3.47 | | 3.47 | |
| Monoglycerides | 2.31 | | 2.31 | | 2.31 | | 2.31 | | 2.31 | |
| Micronized Tricalcium Phosphate | 1.82 | | 1.73 | | 1.64 | | 1.91 | | 2.0 | |
| (avg. particle size 1.87 μm) | | | | | | | | | | |
| Micronized Calcium Citrate (avg. | 803 | g | 763 | g | 723 | g | 843 | g | 883 | g |
| particle size 2.64 μm) | | | | | | | | | | |
| Vit/Min/Taur Premix | 801 | g | 801 | g | 801 | g | 801 | g | 801 | g |
| Ascorbic Acid - Non GMO | 742 | g | 742 | g | 742 | g | 742 | g | 742 | g |
| Sodium Citrate | 511 | g | 511 | g | 511 | g | 511 | g | 511 | g |
| AA Fungal Oil | 433 | g | 433 | g | 433 | g | 433 | g | 433 | g |
| Calcium Carbonate (avg. particle | 346 | g | 363 | g | 381 | g | 329 | g | 311 | g |
| size 2.48 μm) | | | | | | | | | | |
| Magnesium Chloride | 329 | g | 329 | g | 329 | g | 329 | g | 329 | g |
| Potassium Phosphate | 305 | g | 305 | g | 305 | g | 305 | g | 305 | g |
| DHA Algal Oil | 272 | g | 272 | g | 272 | g | 272 | g | 272 | g |
| Potassium Chloride | 186 | g | 186 | g | 186 | g | 186 | g | 186 | g |
| Nucleotide-Choline Premix | 100.6 | g | 100.6 | g | 100.6 | g | 100.6 | g | 100.6 | g |
| Ferrous Sulfate | 76.1 | g | 76.1 | g | 76.1 | g | 76.1 | g | 76.1 | g |
| Vitamin DEK premix | 59.2 | g | 59.2 | g | 59.2 | g | 59.2 | g | 59.2 | g |
| Choline Chloride | 48.1 | g | 48.1 | g | 48.1 | g | 48.1 | g | 48.1 | g |
| Vitamin A (55%) | 9.69 | g | 9.69 | g | 9.69 | g | 9.69 | g | 9.69 | g |
| Potassium Citrate - Non GMO | 6.84 | g | 6.84 | g | 6.84 | g | 6.84 | g | 6.84 | g |
| Copper Sulfate | 3.53 | g | 3.53 | g | 3.53 | g | 3.53 | g | 3.53 | g |
| Riboflavin Non-GMO | 292 | mg | 292 | mg | 292 | mg | 292 | mg | 292 | mg |
| Manganese Sulfate | 109 | mg | 109 | mg | 109 | mg | 109 | mg | 109 | mg |

| | | | | | |
|---|---|---|---|---|---|
| Sodium Chloride | As needed | As needed | As needed | As needed | As needed |

### Examples 12-16

Examples 12-16 illustrate nutritional emulsions of the present disclosure including insoluble calcium salts and monoglycerides, the ingredients of which are listed in the table below. All ingredient amounts are listed as kilogram per approximately 1000 kg batch of product, unless otherwise specified.

The nutritional emulsions were prepared by making at least two separate slurries that were later blended together, heat treated, standardized, and terminally sterilized as described in Examples 2-6.

| Ingredient Name | Example 12 | | Example 13 | | Example 14 | | Example 15 | | Example 16 | |
|---|---|---|---|---|---|---|---|---|---|---|
| Water | Q.S. | | Q.S. | | Q.S. | | Q.S. | | Q.S. | |
| Nonfat Milk | 97.50 | | 97.50 | | 97.50 | | 97.50 | | 97.50 | |
| Corn Syrup | 33.56 | | 33.56 | | 33.56 | | 33.56 | | 33.56 | |
| Corn Syrup Solids | 31.89 | | 31.89 | | 31.89 | | 31.89 | | 31.89 | |
| Medium Chain Triglycerides | 17.20 | | 17.20 | | 17.20 | | 17.20 | | 17.20 | |
| Lactose | 16.43 | | 16.43 | | 16.43 | | 16.43 | | 16.43 | |
| Whey Protein Concentrate | 12.69 | | 12.69 | | 12.69 | | 12.69 | | 12.69 | |
| Soy Oil | 10.30 | | 10.30 | | 10.30 | | 10.30 | | 10.30 | |
| Coconut Oil | 6.30 | | 6.30 | | 6.30 | | 6.30 | | 6.30 | |
| 5% KOH | 4.86 | | 4.86 | | 4.86 | | 4.86 | | 4.86 | |
| Potassium Hydroxide | 243 | g | 243 | g | 243 | g | 243 | g | 243 | g |
| Solids | | | | | | | | | | |
| Ultra-Micronized Tricalcium | 145 | g | 138 | g | 130 | g | 152 | g | 160 | g |
| Phosphate (avg. particle size 2.30 μm) | | | | | | | | | | |
| Ascorbic Acid | 870 | g | 870 | g | 870 | g | 870 | g | 870 | g |
| Vit/Min/Taur Premix | 538 | g | 538 | g | 538 | g | 538 | g | 538 | g |
| Magnesium Chloride | 405 | g | 405 | g | 405 | g | 405 | g | 405 | g |
| Soy Lecithin | 364 | g | 364 | g | 364 | g | 364 | g | 364 | g |
| Monoglycerides | 900 | g | 900 | g | 900 | g | 900 | g | 900 | g |
| AA Fungal Oil | 364 | g | 364 | g | 364 | g | 364 | g | 364 | g |
| Potassium Citrate | 341 | g | 341 | g | 341 | g | 341 | g | 341 | g |
| Nucleotide-Choline Premix | 293 | g | 293 | g | 293 | g | 293 | g | 293 | g |
| Sodium Citrate | 250 | g | 250 | g | 250 | g | 250 | g | 250 | g |
| DHA Algal Oil | 230 | g | 230 | g | 230 | g | 230 | g | 230 | g |
| Potassium Chloride | 138 | g | 138 | g | 138 | g | 138 | g | 138 | g |
| Calcium Carbonate (avg. particle | 145 | g | 160 | g | 152 | g | 138 | g | 130 | g |
| size 2.74 μm) | | | | | | | | | | |
| Vitamin ADEK premix | 82.60 | g | 82.60 | g | 82.60 | g | 82.60 | g | 82.60 | g |
| Ferrous Sulfate | 48.93 | g | 48.93 | g | 48.93 | g | 48.93 | g | 48.93 | g |
| Choline Chloride | 35.00 | g | 35.00 | g | 35.00 | g | 35.00 | g | 35.00 | g |
| L-Carnitine | 30.70 | g | 30.70 | g | 30.70 | g | 30.70 | g | 30.70 | g |
| Beta-carotene | 1.61 | g | 1.61 | g | 1.61 | g | 1.61 | g | 1.61 | g |
| Vitamin A | 1.610 | g | 1.610 | g | 1.610 | g | 1.610 | g | 1.610 | g |
| Vitamin A Palmitate | 880 | mg | 880 | mg | 880 | mg | 880 | mg | 880 | mg |

| | | | | | |
|---|---|---|---|---|---|
| Sodium Chloride | as needed | as needed | as needed | as needed | as needed |
| Potassium Phosphate | as needed | as needed | as needed | as needed | as needed |

### Examples 17-21

Examples 17-21 illustrate nutritional emulsions of the present disclosure including insoluble calcium salts and monoglycerides, the ingredients of which are listed in the table below. All ingredient amounts are listed as kilogram per approximately 1000 kg batch of product, unless otherwise specified.

The nutritional emulsions were prepared by making at least two separate slurries that were later blended together, heat treated, standardized, and terminally sterilized as described in Examples 2-6.

| Ingredient Name | Example 17 | | Example 18 | | Example 19 | | Example 20 | | Example 21 | |
|---|---|---|---|---|---|---|---|---|---|---|
| Water | Q.S. | | Q.S. | | Q.S. | | Q.S. | | Q.S. | |
| Nonfat Milk | 115.8 | | 115.8 | | 115.8 | | 115.8 | | 115.8 | |
| Corn Syrup | 40.4 | | 40.4 | | 40.4 | | 40.4 | | 40.4 | |
| Corny Syrup Solids | 38.4 | | 38.4 | | 38.4 | | 38.4 | | 38.4 | |
| Medium Chain Triglycerides | 20.5 | | 20.5 | | 20.5 | | 20.5 | | 20.5 | |
| Lactose | 20.0 | | 20.0 | | 20.0 | | 20.0 | | 20.0 | |
| Whey Protein Concentrate | 15.1 | | 15.1 | | 15.1 | | 15.1 | | 15.1 | |
| Soy Oil | 12.3 | | 12.3 | | 12.3 | | 12.3 | | 12.3 | |
| Coconut Oil | 7.5 | | 7.5 | | 7.5 | | 7.5 | | 7.5 | |
| 5% KOH | 5.1 | | 5.1 | | 5.1 | | 5.1 | | 5.1 | |
| Potassium Hydroxide | 255.0 | g | 255.0 | g | 255.0 | g | 255.0 | g | 255.0 | g |
| Ultra-Micronized Tricalcium Phosphate | 1.82 | | 1.73 | | 1.64 | | 1.91 | | 2.0 | |
| (avg. particle size 2.30 μm) | | | | | | | | | | |
| Ascorbic Acid | 913.0 | g | 913.0 | g | 913.0 | g | 913.0 | g | 913.0 | g |
| Vit/Min/Taur Premix | 642.2 | g | 642.2 | g | 642.2 | g | 642.2 | g | 642.2 | g |
| Soy Lecithin | 433.0 | g | 433.0 | g | 433.0 | g | 433.0 | g | 433.0 | g |
| Monoglycerides | 2.31 | | 2.31 | | 2.31 | | 2.31 | | 2.31 | |
| AA Fungal Oil | 432.0 | g | 432.0 | g | 432.0 | g | 432.0 | g | 432.0 | g |
| Magnesium Chloride | 431.0 | g | 431.0 | g | 431.0 | g | 431.0 | g | 431.0 | g |
| Sodium Citrate | 328.0 | g | 328.0 | g | 328.0 | g | 328.0 | g | 328.0 | g |
| Calcium Carbonate (avg. particle size | 1.82 | | 2.0 | | 1.91 | | 1.73 | | 1.64 | |
| 2.74 μm) | | | | | | | | | | |
| Nucleotide-Choline Premix | 293.3 | g | 293.3 | g | 293.3 | g | 293.3 | g | 293.3 | g |
| Potassium Citrate | 288.7 | g | 288.7 | g | 288.7 | g | 288.7 | g | 288.7 | g |
| DHA Algal Oil | 272.0 | g | 272.0 | g | 272.0 | g | 272.0 | g | 272.0 | g |
| Potassium Chloride | 233.0 | g | 233.0 | g | 233.0 | g | 233.0 | g | 233.0 | g |
| Vitamin ADEK Premix | 98.9 | g | 98.9 | g | 98.9 | g | 98.9 | g | 98.9 | g |
| Ferrous Sulfate | 58.30 | g | 58.30 | g | 58.30 | g | 58.30 | g | 58.30 | g |
| Choline Chloride | 48.10 | g | 48.10 | g | 48.10 | g | 48.10 | g | 48.10 | g |
| L-Carnitine | 36.60 | g | 36.60 | g | 36.60 | g | 36.60 | g | 36.60 | g |
| Beta-Carotene | 1.68 | g | 1.68 | g | 1.68 | g | 1.68 | g | 1.68 | g |
| Vitamin A | 870 | mg | 870 | mg | 870 | mg | 870 | mg | 870 | mg |
| Vitamin A Palmitate | 478 | mg | 478 | mg | 478 | mg | 478 | mg | 478 | mg |

| | | | | | |
|---|---|---|---|---|---|
| Sodium Chloride | As needed | As needed | As needed | As needed | As needed |
| Potassium Phosphate | As needed | As needed | As needed | As needed | As needed |

### Examples 22-26

Examples 22-26 illustrate nutritional emulsions of the present disclosure including insoluble calcium salts and monoglycerides, the ingredients of which are listed in the table below. All ingredient amounts are listed as kilogram per approximately 1000 kg batch of product, unless otherwise specified.

The nutritional emulsions were prepared by making at least two separate slurries that were later blended together, heat treated, standardized, and terminally sterilized as described in Examples 2-6.

| Ingredient Name | Example 22 | | Example 23 | | Example 24 | | Example 25 | | Example 26 | |
|---|---|---|---|---|---|---|---|---|---|---|
| Water | Q.S. | | Q.S. | | Q.S. | | Q.S. | | Q.S. | |
| Nonfat Milk | 180.7 | | 180.7 | | 180.7 | | 180.7 | | 180.7 | |
| Corn Syrup | 38.39 | | 38.39 | | 38.39 | | 38.39 | | 38.39 | |
| Corn Syrup (on solids basis) | 36.47 | | 36.47 | | 36.47 | | 36.47 | | 36.47 | |
| Medium Chain Triglycerides | 31.60 | | 31.60 | | 31.60 | | 31.60 | | 31.60 | |
| Soy Oil | 18.96 | | 18.96 | | 18.96 | | 18.96 | | 18.96 | |
| Whey Protein Concentrate | 14.11 | | 14.11 | | 14.11 | | 14.11 | | 14.11 | |
| Coconut Oil | 11.56 | | 11.56 | | 11.56 | | 11.56 | | 11.56 | |
| Lactose | 7.13 | | 7.13 | | 7.13 | | 7.13 | | 7.13 | |
| 5% KOH | 6.37 | | 6.37 | | 6.37 | | 6.37 | | 6.37 | |
| Potassium Hydroxide | 319 | g | 319 | g | 319 | g | 319 | g | 319 | g |
| Ultra-Micronized Tricalcium Phosphate | 1.5 | | 1.42 | | 1.35 | | 1.58 | | 1.65 | |
| (avg. particle size 2.30 μm) | | | | | | | | | | |
| Ascorbic Acid | 1.14 | | 1.14 | | 1.14 | | 1.14 | | 1.14 | |
| Vit/Min/Taur Premix | 802.7 | g | 802.7 | g | 802.7 | g | 802.7 | g | 802.7 | g |
| Calcium Carbonate (avg. particle size | 500 | g | 475 | g | 450 | g | 525 | g | 550 | g |
| 2.74 μm) | | | | | | | | | | |
| Soy Lecithin | 659 | g | 659 | g | 659 | g | 659 | g | 659 | g |
| Monoglycerides | 2.31 | | 2.31 | | 2.31 | | 2.31 | | 2.31 | |
| Magnesium Chloride | 554 | g | 554 | g | 554 | g | 554 | g | 554 | g |
| AA Fungal Oil | 541 | g | 541 | g | 541 | g | 541 | g | 541 | g |
| Sodium Citrate | 438.5 | g | 438.5 | g | 438.5 | g | 438.5 | g | 438.5 | g |
| Nucleotide-Choline Premix | 366.5 | g | 366.5 | g | 366.5 | g | 366.5 | g | 366.5 | g |
| DHA Algal Oil | 339.0 | g | 339.0 | g | 339.0 | g | 339.0 | g | 339.0 | g |
| Vitamin A, D3, E, K1 Premix | 123.60 | g | 123.60 | g | 123.60 | g | 123.60 | g | 123.60 | g |
| Ferrous Sulfate | 72.97 | g | 72.97 | g | 72.97 | g | 72.97 | g | 72.97 | g |
| Choline Chloride | 60.07 | g | 60.07 | g | 60.07 | g | 60.07 | g | 60.07 | g |
| L-Carnitine | 40.34 | g | 40.34 | g | 40.34 | g | 40.34 | g | 40.34 | g |
| Potassium Citrate (2) | 4.60 | g | 4.60 | g | 4.60 | g | 4.60 | g | 4.60 | g |
| Thiamine HCL | 4.34 | g | 4.34 | g | 4.34 | g | 4.34 | g | 4.34 | g |
| Riboflavin | 1.76 | g | 1.76 | g | 1.76 | g | 1.76 | g | 1.76 | g |
| Vitamin A | 463 | mg | 463 | mg | 463 | mg | 463 | mg | 463 | mg |
| Vitamin A Palmitate | 254 | mg | 254 | mg | 254 | mg | 254 | mg | 254 | mg |
| Beta-carotene | 210 | mg | 210 | mg | 210 | mg | 210 | mg | 210 | mg |

| | | | | | |
|---|---|---|---|---|---|
| Potassium Citrate (1) | as needed | as needed | as needed | as needed | as needed |
| Potassium Chloride | as needed | as needed | as needed | as needed | as needed |
| Potassium Phosphate | as needed | as needed | as needed | as needed | as needed |

### Examples 27-31

Examples 27-31 illustrate nutritional emulsions of the present disclosure including insoluble calcium salts and monoglycerides, the ingredients of which are listed in the table below. All ingredient amounts are listed as kilogram per approximately 1000 kg batch of product, unless otherwise specified.

The nutritional emulsions were prepared by making at least two separate slurries that were later blended together, heat treated, standardized, and terminally sterilized as described in Examples 2-6.

| Ingredient Name | Example 27 | | Example 28 | | Example 29 | | Example 30 | | Example 31 | |
|---|---|---|---|---|---|---|---|---|---|---|
| Water | 747.4 | | 747.4 | | 747.4 | | 747.4 | | 747.4 | |
| Nonfat Milk | 127.3 | | 127.3 | | 127.3 | | 127.3 | | 127.3 | |
| Corn Syrup | 38.8 | | 38.8 | | 38.8 | | 38.8 | | 38.8 | |
| Corn Syrup Solids | 36.9 | | 36.9 | | 36.9 | | 36.9 | | 36.9 | |
| Medium Chain Triglycerides | 20.6 | | 20.6 | | 20.6 | | 20.6 | | 20.6 | |
| Whey Protein Concentrate | 16.6 | | 16.6 | | 16.6 | | 16.6 | | 16.6 | |
| Lactose | 16.3 | | 16.3 | | 16.3 | | 16.3 | | 16.3 | |
| Soy Oil | 12.4 | | 12.4 | | 12.4 | | 12.4 | | 12.4 | |
| Coconut Oil | 7.48 | | 7.48 | | 7.48 | | 7.48 | | 7.48 | |
| 5% KOH | 5.10 | | 5.10 | | 5.10 | | 5.10 | | 5.10 | |
| Potassium Hydroxide | 255 | g | 255 | g | 255 | g | 255 | g | 255 | g |
| Solids | | | | | | | | | | |
| Ultra-Micronized Tricalcium | 1.5 | | 1.42 | | 1.35 | | 1.58 | | 1.65 | |
| Phosphate (avg. particle size | | | | | | | | | | |
| 1.87 μm) | | | | | | | | | | |
| Ascorbic Acid | 913 | g | 913 | g | 913 | g | 913 | g | 913 | g |
| Vit/Min/Taur Premix | 642 | g | 642 | g | 642 | g | 642 | g | 642 | g |
| Calcium Carbonate (avg. particle | 500 | g | 475 | g | 450 | g | 525 | g | 550 | g |
| size 2.48 μm) | | | | | | | | | | |
| Soy Lecithin | 433 | g | 433 | g | 433 | g | 433 | g | 433 | g |
| Monoglycerides | 1.5 | | 1.5 | | 1.5 | | 1.5 | | 1.5 | |
| AA Fungal Oil | 433 | g | 433 | g | 433 | g | 433 | g | 433 | g |
| Magnesium Chloride | 424 | g | 424 | g | 424 | g | 424 | g | 424 | g |
| Nucleotide-Choline Premix | 293 | g | 293 | g | 293 | g | 293 | g | 293 | g |
| DHA Algal Oil | 272 | g | 272 | g | 272 | g | 272 | g | 272 | g |
| Potassium Citrate | 261 | g | 261 | g | 261 | g | 261 | g | 261 | g |
| Sodium Citrate | 203 | g | 203 | g | 203 | g | 203 | g | 203 | g |
| Potassium Chloride | 196 | g | 196 | g | 196 | g | 196 | g | 196 | g |
| Mixed Carotenoids Suspension | 110.23 | g | 110.23 | g | 110.23 | g | 110.23 | g | 110.23 | g |
| Vitamin ADEK Premix | 98.9 | g | 98.9 | g | 98.9 | g | 98.9 | g | 98.9 | g |
| Ferrous Sulfate | 58.4 | g | 58.4 | g | 58.4 | g | 58.4 | g | 58.4 | g |
| Choline Chloride | 48.1 | g | 48.1 | g | 48.1 | g | 48.1 | g | 48.1 | g |
| L-Carnitine | 36.6 | g | 36.6 | g | 36.6 | g | 36.6 | g | 36.6 | g |
| Riboflavin | 2.11 | g | 2.11 | g | 2.11 | g | 2.11 | g | 2.11 | g |
| Vitamin A | 1.25 | g | 1.25 | g | 1.25 | g | 1.25 | g | 1.25 | g |
| Vitamin A Palmitate | 685 | mg | 685 | mg | 685 | mg | 685 | mg | 685 | mg |

| | | | | | |
|---|---|---|---|---|---|
| Sodium Chloride | as needed | as needed | as needed | as needed | as needed |
| Potassium Phosphate | as needed | as needed | as needed | as needed | as needed |

What is claimed is:

1. A stabilized liquid nutritional composition comprising a first insoluble calcium salt, a second insoluble calcium salt, an emulsifier, and a fat, wherein the first insoluble calcium salt and the second insoluble calcium salt have different average particle sizes.

2. The stabilized liquid nutritional composition of claim 1 further comprising a third insoluble calcium salt having an average particle size different from the first insoluble calcium salt and the second insoluble calcium salt.

3. The stabilized liquid nutritional composition of claim 1 wherein the emulsifier comprises monoglycerides.

4. The stabilized liquid nutritional composition of claim 3 wherein the emulsifier further comprises diglycerides.

5. The stabilized liquid nutritional composition of claim 1 wherein the first insoluble calcium salt has an average particle size of from about 1.5 μm to about 2.5 μm and the second insoluble calcium salt has an average particle size of from about 2 μm to about 3 μm.

6. The stabilized liquid nutritional composition of claim 5 wherein the third insoluble calcium salt has an average particle size of from about 2.5 μm to about 4.5 μm.

7. The stabilized liquid nutritional composition of claim 1 wherein the first insoluble calcium salt and the second insoluble calcium salt are present in a total amount of from about 0.02 wt. % to about 1 wt. %.

8. The stabilized liquid nutritional composition of claim 7 wherein the first insoluble calcium salt and the second insoluble calcium salt are present in a weight ratio of from about 20:80 to about 80:20.

9. The stabilized liquid nutritional composition of claim 1 wherein the first insoluble calcium salt and the second insoluble calcium salt are selected from the group consisting of calcium carbonate, calcium citrate, calcium phosphate, dicalcium phosphate, tricalcium phosphate, and combinations thereof.

10. The stabilized liquid nutritional composition of claim 1 wherein the emulsifier is present in an amount of no more than 12% by weight of total fat in the liquid nutritional composition.

11. The stabilized liquid nutritional composition of claim 10 wherein the emulsifier comprises monoglycerides.

12. The stabilized liquid nutritional composition of claim 1 wherein the liquid nutritional composition is substantially free of carrageenan.

13. A stabilized liquid infant formula comprising a first insoluble calcium salt, a second insoluble calcium salt, an emulsifier, and a fat, wherein the first insoluble calcium salt and the second insoluble calcium salts have different average particle sizes, wherein the first insoluble calcium salt and the second insoluble calcium salt are selected from the group consisting of calcium carbonate, calcium citrate, calcium phosphate, dicalcium phosphate, tricalcium phosphate, and combinations thereof, and wherein the emulsifier comprises monoglycerides.

14. The stabilized liquid infant formula of claim 13 wherein the first insoluble calcium salt has an average particle size of from about 1.5 μm to about 2.5 μm and the second insoluble calcium salt has an average particle size of from about 2 μm to about 3 μm.

15. The stabilized liquid infant formula of claim 13 wherein the emulsifier additionally comprises diglycerides.

16. The stabilized liquid infant formula of claim 13 wherein the liquid nutritional composition is substantially free of carrageenan.

17. A process for manufacturing a stabilized liquid nutritional composition, the process comprising:
introducing a first insoluble calcium salt, a second insoluble calcium salt, and an emulsifier with a fat to form a fat blend, wherein the first insoluble calcium salt and the second insoluble calcium salt have different average particle sizes, and wherein the emulsifier comprises monoglycerides; and
mixing the fat blend with a carbohydrate blend to form the stabilized liquid.

18. The process of claim 17 wherein the first insoluble calcium salt has an average particle size of from about 1.5 μm to about 2.5 μm and the second insoluble calcium salt has an average particle size of from about 2 μm to about 3 μm.

19. The process of claim 17 wherein the fat blend additionally comprises a third insoluble calcium salt, the third insoluble calcium salt having an average particle size different that the first insoluble calcium salt and the second insoluble calcium salt.
